(19) United States
(12) Patent Application Publication
(10) Pub. No.: US 2007/0240896 A1
(43) Pub. Date: Oct. 18, 2007

(54) PROTECTIVE SLEEVE ASSEMBLY HAVING AN INTEGRAL CLOSURE MEMBER AND METHODS OF MANUFACTURE AND USE THEREOF

(76) Inventors: Donald C. Ott JR., Exton, PA (US); David Andrew Harris, Coatesville, PA (US); Linwood Ludy, Pottstown, PA (US); Cassie M. Malloy, Blue Bell, PA (US)

Correspondence Address: ROBERT L. STERNS;Dickinson Wright PLLC, Suite 2000, 38525 Woodward Avenue, Bloomfield Hills, MI, 48304-5092, US

(21) Appl. No.: 11/735,571

(22) Filed: Apr. 16, 2007

Related U.S. Application Data
(60) Provisional application No. 60/792,522, filed on Apr. 17, 2006.

(51) Int. Cl. H02G 15/08

(52) U.S. Cl. 174/93

(57) ABSTRACT

A protective sleeve assembly for elongate members has a tubular wall with an inner surface providing a cavity extending along a longitudinal axis between opposite ends of the sleeve. The assembly includes at least one closure member laid-in with the tubular wall, such that at least a portion of the closure member within the tubular wall is moveable relative to the tubular wall. At least a portion of the wall inner surface is constricted toward the longitudinal axis to engage the elongate member upon pulling the closure member outwardly from the wall. The sleeve is expandable radially outwardly from the longitudinal axis to allow relative axial movement between the sleeve assembly and the elongate member by pulling the sleeve wall radially outwardly.

### CROSS-REFERENCE TO RELATED APPLICATION

This application claims the benefit of U.S. Provisional Application Ser. No. 60/792,522, filed Apr. 17, 2006, which is incorporated herein by reference in its entirety.

### BACKGROUND OF THE INVENTION

1. Technical Field

This invention relates generally to sleeves for protecting elongate members and more particularly to tubular protection sleeves having a closure mechanism for maintaining the sleeves against relative axial movement along the elongate members.

2. Related Art

Tubular sleeves are known for use to protect and provide a barrier to heat radiation to elongate members, such as wires and tubing, contained within the sleeves. The sleeves are commonly constructed from abrasion resistant and/or heat resistant and/or fire retardant yarns to withstand relatively high temperatures. Sometimes the sleeves are used to insulate high temperature tubes, such as those providing a conduit for hot liquid, to inhibit the heat from radiating beyond the confines of the tubing. Also, the sleeves are used to protect the contents of the sleeves, such as a wire harness, for example, from heat external to the sleeves.

The sleeves are commonly attached to the elongate members to prevent relative axial movement of the sleeves along the elongate members. To attach a sleeve to the respective elongate members, typically a separate clamp, such as a hose type clamp is used. Unfortunately, clamps often require a separate tool, such as a screwdriver, to be used to secure the clamp about the sleeve in assembly, and to remove the clamp in service. In addition, clamps can increase the time required to secure the sleeving to the elongate members, they can be unsightly, they can get hot, they can cause damage to adjacent components, and they can also prove costly. Other than clamps, it is common to wrap high temperature tape about the circumference of the sleeve, with a portion of the tape typically being adhered to the elongate member to prevent relative movement between the sleeve and the elongate member. Unfortunately, as with clamps, using tape can increase the time required to secure the sleeving in place, and it can prove cumbersome and difficult to apply, particularly in tight spaces. Also, utilizing tape requires making sure an adequate supply of tape is on hand at all times, and it can also make servicing the elongate items difficult, in that the tape may be difficult to remove once applied. Further, removal of the tape may cause damage to the underlying sleeving, thereby adding further cost associated with the repair or replacement of the damaged sleeving. In addition, tapes can be unsightly, which could be a concern in areas having high visibility. Thus, although clamps, tapes, and other secondary mechanisms used to secure protective sleeving to elongate members can prove effective in preventing relative movement between the sleeving and the elongate members, they typically come with negative consequences.

A sleeve manufactured in accordance with the present invention overcomes or greatly minimizes any limitations of the prior art described above.

### SUMMARY OF THE INVENTION

A unitized tubular sleeve assembly provides protection to elongate members contained within a sleeve of the assembly. The assembly has material formed into a tubular wall defining an inner surface of the sleeve and an enclosed tubular cavity extending axially along a longitudinal axis between opposite ends of the sleeve. The assembly includes at least one closure member laid-in with the tubular wall material, and as a result of being laid-in, at least a portion of the closure member can move circumferentially relative to the tubular wall. As such, by pulling on the closure member, at least a portion of the wall inner surface is constricted radially toward the longitudinal axis for secure engagement with the elongate member. Conversely, by pulling the sleeve wall radially outwardly, the sleeve wall can be expanded radially outwardly from the longitudinal axis to allow relative axial movement between the sleeve assembly and the elongate member.

Accordingly, the sleeve assembly can be readily secured to any elongate members contained within the cavity by pulling a portion of the closure member radially outwardly under tension from the sleeve. Thereafter, the sleeve assembly can be selectively released from the elongate members for relative movement therewith by releasing the closure member from tension and pulling radially outwardly on the wall of the sleeve. As such, the sleeve assembly is able to be easily secured to elongate members without the need of additional secondary securing members, such as clamps or tapes, or tools, and is also easily removable from the elongate members without the need of tools. In addition, the sleeve assembly is economical in manufacture and well as in use, while also being aesthetically pleasing and having a long and useful life.

Another aspect of the invention provides a unitized heat resistant tubular sleeve assembly that provides a thermal barrier to elongate members contained within a sleeve of the assembly. The assembly has heat resistant material knitted into a tubular wall defining an inner surface of the sleeve and an enclosed tubular cavity extending axially along a longitudinal axis between opposite ends of the sleeve. The assembly includes at least one heat resistant closure member laid-in with the tubular wall material, and as a result of being laid-in, at least a portion of the closure member can move circumferentially relative to the tubular wall. As such, by pulling on the closure member to extend it outwardly from the wall, at least a portion of the wall inner surface constricts radially toward the longitudinal axis for secure engagement with the elongate member. Conversely, by pulling the sleeve wall radially outwardly, the sleeve wall can be expanded radially outwardly from the longitudinal axis to allow relative axial movement between the sleeve assembly and the elongate member.

Another aspect of the invention provides a method of constructing a tubular integral sleeve assembly for protecting elongate members contained within the sleeve assembly. The method includes forming a tubular sleeve to define a tubular cavity extending along a longitudinal axis between opposite ends, and further includes laying-in at least one closure member into the sleeve material at least partially about a circumference of the sleeve. With at least a portion of the closure member being laid-in, the portion can move circumferentially relative to the sleeve material, thereby providing a mechanism in which to constrict and expand the sleeve radially about the longitudinal axis.

Another aspect of the invention provides a method of constructing a tubular integral sleeve assembly to provide a barrier to heat radiation toward or away from elongate members contained within the sleeve assembly. The method includes knitting a tubular sleeve with a heat resistant material to define a tubular cavity extending along a longitudinal axis between opposite ends, and further includes laying-in at least one heat resistant closure member into the sleeve material at least partially about a circumference of the sleeve. With at least a portion of the closure member being laid-in, the portion can move circumferentially relative to the sleeve material, thereby providing a mechanism in which to constrict and expand the sleeve radially about the longitudinal axis.

Another aspect of the invention provides a method of securing a tubular sleeve assembly to an elongate member to protect an elongate member contained therein. The sleeve assembly has a tubular sleeve defining a cavity and a closure member at least partially laid-in with the sleeve. The method includes disposing the elongate member within the cavity of the sleeve; and next, extending a portion of the closure member outwardly from the sleeve to cause the laid-in portion of the closure member to constrict at least a portion of the sleeve into secure engagement with the elongate member.

Sleeve assemblies constructed in accordance with one aspect of the invention are useful for shielding heat radiation from entering and/or exiting the tubular cavity of the sleeve assembly. The sleeve assemblies can be made to accommodate virtually any package size and shape by adjusting their cavity diameter, their flexibility, and their length in manufacture, and can be equipped with a variety of types and numbers of closure members in accordance with the invention. The sleeve assemblies are readily securable to an elongate member to prevent relative axial movement of the sleeve along the elongate member. The sleeve assemblies are also readily removable from the elongate member without the need of secondary tools. In addition, sleeve assemblies constructed in accordance with the invention are relatively economical in manufacture and in use, and exhibit a long and useful life.

### BRIEF DESCRIPTION OF THE DRAWINGS

These and other objects, features and advantages will become readily apparent to those skilled in the art in view of the following detailed description of the presently preferred embodiments and best mode, appended claims, and accompanying drawings, in which:

FIG. 1 is a perspective side view of a knitted sleeve assembly having a pair of closure members constructed according to one presently preferred embodiment of the invention shown in an open position;

FIG. 2 is a view similar to FIG. 1 showing the sleeve assembly in a closed position about an elongate member;

FIG. 3 is a perspective view of one end of the sleeve assembly of FIG. 1;

FIG. 4 a view similar to FIG. 3 showing an opposite end of the sleeve assembly; and

FIG. 5 is a perspective side view of the sleeve assembly showing an inner and outer wall of the assembly with the inner wall unfolded in an extended position axially outwardly from the outer wall.

### DETAILED DESCRIPTION OF PREFERRED EMBODIMENTS

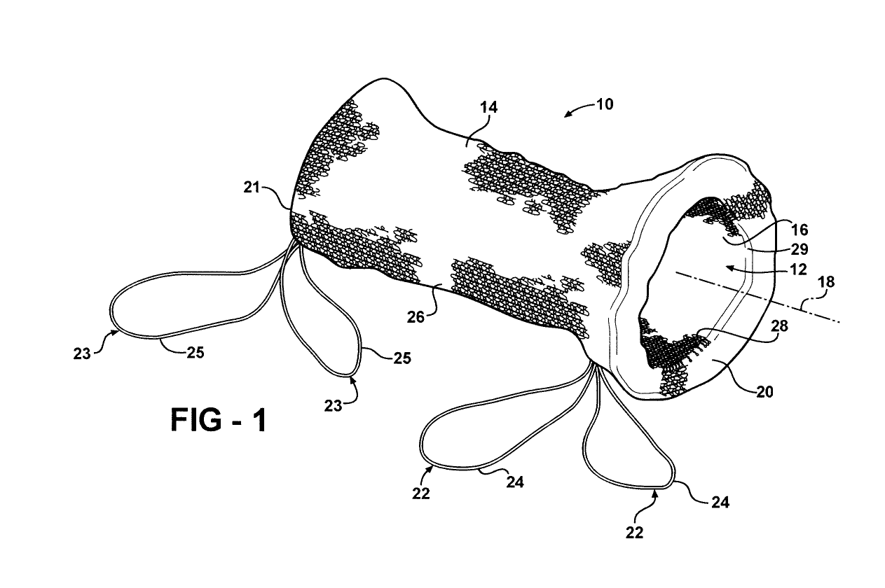

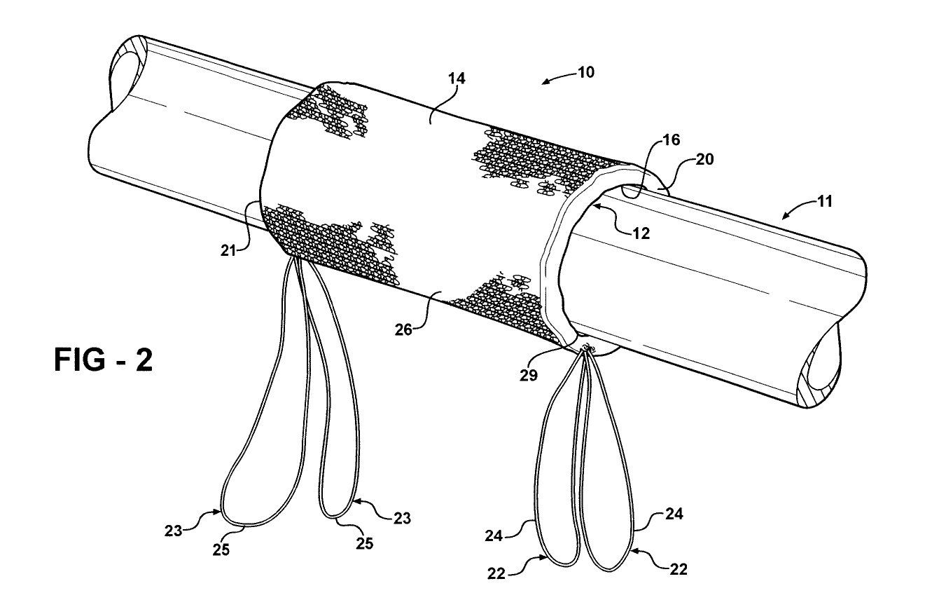

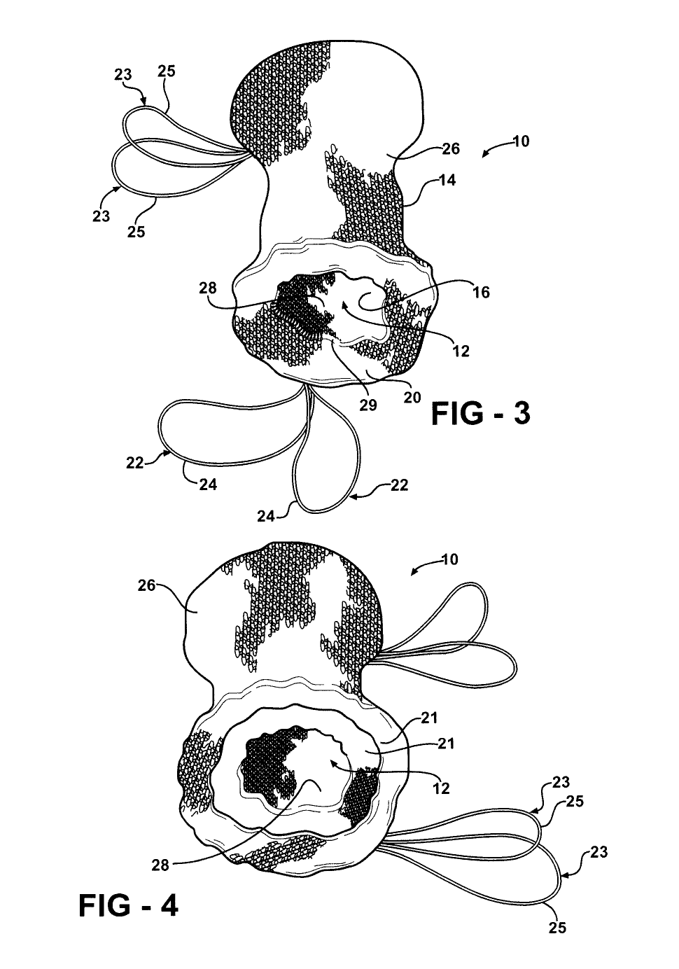

Referring in more detail to the drawings, FIGS. 1-6 show a tubular sleeve assembly 10 constructed according to one presently preferred embodiment of the invention. The sleeve assembly provides protection to one or more elongate members 11 (FIG. 2) received within an enclosed tubular cavity 12 of the assembly 10. The assembly 10 has a plurality of yarns knitted into a tubular walled sleeve 14 having an inner surface 16 defining the cavity 12 extending axially along a longitudinal axis 18 between opposite ends 20, 21 of the sleeve 14. The sleeve assembly 10 has at least one elongate closure member, and represented here, for example, as a pair of elongate closure members 22, 23 integrally constructed with the sleeve 14 to provide the sleeve assembly 10 as a unitized, one-piece structure. At least a portion of the closure members 22, 23 can be pulled outwardly, represented here as respective loop portions 24, 25, for example, thereby causing the outwardly extending loop portion 24, 25 to increase in size, while causing the sleeve wall inner surface 16 to constrict radially toward the longitudinal axis 18 to a closed position (FIG. 2). When in the closed position, the sleeve assembly 10 is secured against relative axial movement along the elongate members 11. In addition, the sleeve wall inner surface 16 can be expanded radially outwardly from the longitudinal axis 18 and out of secure engagement with the elongate members 11, such as by pulling a portion of the sleeve 14 radially outwardly, thereby causing the closure members 22, 23 to be at least partially retracted within the sleeve 14 and causing the outwardly extending loop portions 24, to decrease in size. Accordingly, the sleeve assembly 10 is readily securable to and removable from the elongate members 11 without the need for additional fasteners, clamps, tapes, or tools as a result of being able to manipulate the closure members 22, 23 in the prescribed manner.

The knitted sleeve 14, in one presently preferred construction, can be constructed at least in part from a heat resistant material suitable for withstanding high temperature environments ranging from between about −60 to 1400 degrees centigrade. Some of the selected yarns could be formed with silica, fiberglass, ceramic, basalt, aramid or carbon, by way of example and without limitations. In some applications of extreme heat, it may be desirable to heat treat the sleeve material to remove organic content therefrom, thereby increasing the heat resistance capacity of the sleeve 14. If desired, the sleeve 14 could also be coated to further enhance its heat resistance, and possibly to improve its abrasion resistance. It should be recognized that the sleeve could be constructed utilizing any type of material suitable for knitting a tubular sleeve, such as polyester, nylon, polypropylene, polyethylene, acrylic, cotton, rayon, and fire retardant (FR) versions of all the aforementioned materials, as desired for the intended application. Further, at least a portion of the sleeve 14 could be knitted using a heat-shrinkable yarn, which could be provided as a bi-component filament, for example, wherein one of the components of the bi-component yarn is heat-shrinkable. Accordingly, not only can the sleeve 14 be secured against axial movement to the elongate member 11 via cinching the closure members 22, 23, but it could also be heat shrunk in the region containing the heat-shrinkable yarns to close in a generally tight fit about the elongate member 11.

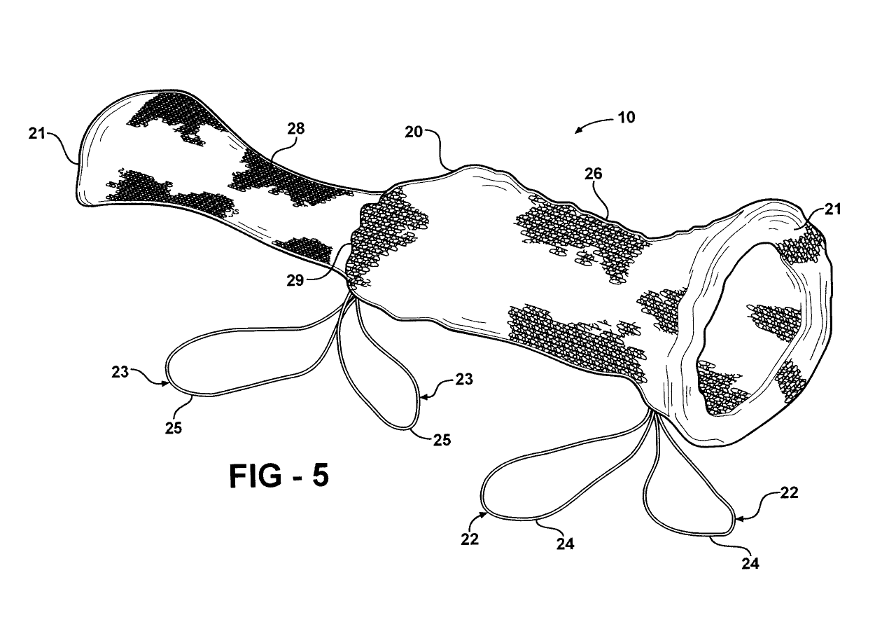

As best shown in FIG. 5, the sleeve 14 is represented here, for example, as having an outer wall 26 and an inner wall 28, wherein the outer and inner walls 26, 28 are attached together as one piece about a circumferential region 29 that corresponds generally to the resulting end 20 of the sleeve. The inner wall 28 is foldable for receipt within the outer wall 26, such that the circumferential region 29 of attachment between the walls 26, 28 establishes one end 20 of the sleeve assembly 10, while opposite ends 21 of the walls 26, 28 establish the other end 21 of the assembly 10. Accordingly, it should be recognized that the circumferential region 29 in the embodiment shown represents the approximate midsection between the opposite ends 21 of the outer and inner walls 26, 28 when in there unfolded position. Given this construction results in reverse folding one wall 28 within the other wall 26, it should be recognized that both walls 26, 28 can be constructed from the same type of yarn, or they can be constructed using different types of yarn, such as those mentioned above, to provide the walls 26, 28 with different characteristics. Accordingly, the outer wall 26 can be constructed to meet one performance criteria, while the inner wall 28 can be constructed to achieve a different performance criteria. It should also be recognized that the sleeve assembly 10 could be constructed having a single wall, rather than overlapping multiple walls, if desired. With the sleeve 14 being knitted, the walls 26, 28 are highly flexible and free to expand radially and contract radially such that elongate members, including fittings or connectors associated therewith, can be readily received in the cavity 12 of the sleeve 14.

The closure members 22, 23 of the sleeve assembly 10 can be constructed from the same material as the sleeve 14, such as from those materials mentioned above, for example. Where the sleeve assembly 10 is intended to be heat resistant or fire retardant, it should be recognized that the closure member or members 22, 23 are preferably constructed from a heat resistant or fire retardant material suitable for withstanding the intended environment. The closure members 22, 23 can be provided as a braided, knitted or monofilament cords, wires, sheathed wires, ropes or tapes, for example, (referred to hereafter for convenience as cords) with the closure members 22, 23 being laid-in with the knitted yarns of the sleeve 14. As a result of being laid-in, at least a portion of the closure members 22, 23 can be moved circumferentially relative to and through the yarns forming the sleeve 14. The closure members 22, 23 are represented here as being laid-in adjacent the opposite ends 20, 21 of the sleeve 14, although it should be recognized that one or more closure members 22, 23 could be laid-in at any desired axial location between the ends 20, 21 of the sleeve 14. Accordingly, depending on the application and the length of the sleeve 14, any number of closure members 22, 23 could be provided by being laid-in with either or both of the knitted sleeve walls 26, 28 in unitized fashion at the desired location along the length of the sleeve 14.

The closure members 22, 23, although shown here as having a pair of outwardly extending loop portions 24, 25, are each constructed from single continuous open ended pieces of cord. To facilitate constricting the sleeve 14, the separate cords of the closure members 22, 23 are preferably laid-in over two or more circumferential turns about the circumference of the sleeve 14, with opposite free ends (not shown) of each cord preferably being prevented from being pulled out of the sleeve 14, such as by being tied or knitted to one another, or to a portion of the sleeve 14. Otherwise, the free ends of the closure members 22, 23 could be left to extend from the sleeve 14, if desired. In addition, to further inhibit inadvertent removal of the closure members 22, 23 from the sleeve 14, the closure members 22, 23 and/or at least the portion of the sleeve 14 through which the closure members 22, 23 are laid in could be coated with a “grippy or tacky” coating or material, such as being rubberized, for example. As such, the surfaces of the closure members 22, 23 extending through the wall of the sleeve 14 will exhibit increased friction against the wall. By way of example, in the embodiment shown, the separate closure members 22, 23 are wrapped about the circumference of the sleeve 14 over four circumferential turns. Accordingly, one loop portion 24, 25 can be formed by pulling a portion of the cord outwardly, wherein a portion of the cord is generally accessible externally from the sleeve 14 on at least one of the cord turns, and another loop portion 24, 25 can be formed by pulling outwardly on another accessible portion of a different cord turn.

With each cord being provided as a continuous filament, when one loop portion 24, 25 is pulled outwardly to a maximum extent, the remaining loop portion 24, 25 will be retracted into the sleeve 14. Preferably, a pair of locations accessible externally from the sleeve 14 on separate cord turns are pulled simultaneously outwardly from the sleeve 14 to form the pair of loop portions 24, 25 in a draw string affect, wherein the loop portions 24, 25 can be manipulated to be generally equal in size. By forming the loop portions 24, 25, the sections of the sleeve 14 underlying the closure members 22, 23 are constricted to engage the elongate members 11 received in the cavity 12. Upon drawing the loop portions 24, 25 outwardly until they are generally taut, the sleeve assembly 10 is secured against relative axial movement with the elongate members 11. The cords are preferably maintained under tension in their taut state to continually secure the sleeve assembly 10 against relative axial movement along the elongate members 11. To maintain the cords in their taut state, they can be fastened or tied off to prevent their relaxing or returning into the sleeve 14. For example, the loop portions 24, 25 can be tied together, presuming they are long enough, or they could be secured or tied to adjacent objects. Otherwise, if suitable for the intended application, separate mechanisms or fasteners, such as cord locks and the like, could be used. In addition, the loop portions 24, 25, as mentioned above in describing the possible materials for construction of the closure members 22, 23, could contain a wire filament, either internally or externally, to allow the loop portions 24, 25 to be twisted to one another.

It should be recognized that sleeve assemblies 10 constructed in accordance with the invention are suitable for use in a variety of applications, regardless of the sizes and lengths required. For example, they could be used in automotive, marine, industrial, aeronautical or aerospace applications, or any other application wherein protective sleeves are desired to protect elongate members, such as, from abrasion or high temperatures.

It is to be understood that the above detailed description is with regard to some presently preferred embodiments, and that other embodiments which accomplish the same function are incorporated herein within the scope of any ultimately allowed patent claims.

What is claimed is:

1. A tubular sleeve assembly for providing protection to elongate members, comprising:
a tubular wall having an outer surface and an inner surface defining a cavity for receipt of the elongate members; and
at least one elongate closure member laid-in with said tubular wall about a portion of its circumference with said closure member being accessible from said outer surface of said wall, said closure member being extendable outwardly from said wall to impart a constricting force within said wall to bring said wall into engagement about an outer surface of the elongate members.

2. The tubular sleeve assembly of claim 1 wherein said wall is knitted.

3. The tubular sleeve assembly of claim 2 wherein said wall is formed from yarn capable of withstanding temperatures between about −60 to 1400 degrees centigrade.

4. The tubular sleeve assembly of claim 3 wherein said closure member is constructed from material capable of withstanding temperatures between about −60 to 1400 degrees centigrade.

5. The tubular sleeve assembly of claim 1 wherein a pair of said closure members are laid-in with said wall.

6. The tubular sleeve assembly of claim 5 wherein one of said closure members is adjacent one end of said wall and another of said closure members is adjacent an opposite end of said wall.

7. The tubular sleeve assembly of claim 1 wherein said tubular wall has an inner wall attached to an outer wall, said inner wall being received coaxially within said outer wall.

8. The tubular sleeve assembly of claim 7 wherein said inner wall is constructed from one type of yarn and said outer wall is constructed from another type of yarn, said types of yarn being different.

9. The tubular sleeve assembly of claim 7 wherein said inner wall and said outer wall are constructed as a continuous wall.

10. The tubular sleeve assembly of claim 9 wherein said inner wall and said outer wall are joined to one another across a circumferential region wherein one of said at least one closure member is laid-in adjacent said circumferential region.

11. The tubular sleeve assembly of claim 1 wherein a plurality of said closure members are laid-in along a length of said wall in axially spaced relation to one another.

12. The tubular sleeve assembly of claim 2 wherein said wall is knitted at least partially from heat-shrinkable yarn.

13. The tubular sleeve assembly of claim 1 wherein said at least one closure member is constructed at least partially from wire.

14. A method of constructing a tubular sleeve assembly that provides protection to elongate members contained within the assembly, comprising the steps of:
constructing a tubular wall providing a cavity extending along a longitudinal axis between opposite open ends of said sleeve for receipt of the elongate members; and
laying-in at least one closure member within said wall with at least a portion of said closure member being extendible externally from said wall to constrict said wall inwardly toward said longitudinal axis and retractable within said wall to expand said wall outwardly from said longitudinal axis.

15. The method of claim 14 wherein said constructing step is performed by knitting said tubular wall.

16. The method of claim 14 further including constructing said tubular wall from a material capable of withstanding temperatures between about −60 to 1400 degrees centigrade.

17. The method of claim 14 further including disposing a portion of said tubular wall coaxially within another portion of said tubular wall to provide an inner wall and an outer wall connected together at circumferential region.

18. The method of claim 17 further including constructing said inner wall and said outer wall from different types of yarn.

19. The method of claim 17 further including laying-in one of said at least one closure member adjacent one of said ends and a separate one of said at least one closure member adjacent an opposite one of said ends.

20. The method of claim 19 further including forming said circumferential region at one of said ends.

21. The method of claim 15 further including knitting at least a portion of said wall using heat-shrinkable yarn.

22. The method of claim 14 further including forming said at least one closure member at least partially from wire.

23. A method of securing a protective sleeve assembly to an elongate member, said sleeve assembly having a tubular wall defining a cavity extending along a longitudinal axis of the sleeve for receipt of the elongate member, at least one closure member being laid-in circumferentially about a portion of the wall so that a portion of said closure member is moveable within said wall while another portion of said closure member is extended outwardly from said wall causing said wall to constrict radially inwardly and a portion of said closure member being moveable from being outside said wall to being inside said wall allowing said wall to expand radially outwardly, the method comprising the steps of:
disposing the elongate member in said cavity; and
extending an accessible portion of said closure member outwardly from said wall causing said wall to constrict radially inwardly toward said longitudinal axis into engagement with said elongate member.

24. The method of claim 23 further comprising extending at least two separate accessible portions of said closure member outwardly from said wall during the extending step.

25. The method of claim 24 further including maintaining said wall in engagement with said elongate member by securing the extended portions of the closure member against returning into said wall.

26. The method of claim 25 further including tying the extending portions to one another.

27. The method of claim 23 further including heat shrinking at least a portion of said wall.

28. The method of claim 23 further including constructing a pair of said closure members having wire portions and twisting said wire portions of said closure members to one another.
